(19) United States
(12) Patent Application Publication
(10) Pub. No.: US 2008/0232482 A1
(43) Pub. Date: Sep. 25, 2008

(54) METHOD AND APPARATUS FOR CONSTRUCTING RECEIVER DIVERSITY FOR OFDM SIGNALS

(75) Inventor: Qin Liu, FREMONT, CA (US)

Correspondence Address: FRANKLIN (LIN) YANG, 91 CANTERBURY GATE, LYNBROOK, NY, 11563, US

(73) Assignee: LEGEND SILICON CORP., FREMONT, CA (US)

(21) Appl. No.: 11/687,698

(22) Filed: Mar. 19, 2007

(51) Int. Cl. H04K 1/10; H04L 27/28

(52) U.S. Cl. 375/260; 375/E07.002

(57) ABSTRACT

In an orthogonal frequency division multiplex (OFDM) communication system, a method at a receiver end is provided. The method comprises the steps of: providing a frame; providing a guard interval (GI) associated with the frame, the GI having a length in a time domain larger or longer than a channel span; and extracting OFDM information comprising a first OFDM information starting from a first point after the channel span to a first end point within the frame.

### FIELD OF THE INVENTION

The present invention relates generally to receiver diversity, more specifically the present invention relates to receiver diversity without additional antenna.

### BACKGROUND

Orthogonal Frequency Division Multiplexing (OFDM) is a promising communication scheme to achieve high data rate transmission. In order to improve reception performance, antenna diversity is a direct choice but this introduces extra cost of duplicate receivers.

Therefore, it is desirable to obtain diversity without the cost of extra antennas.

### SUMMARY OF THE INVENTION

In an OFDM system, diversity is obtained by exploring the structure of an OFDM symbol.

In an orthogonal frequency division multiplex (OFDM) communication system, a method at a receiver end is provided. The method comprises the steps of: providing a frame; providing a guard interval (GI) associated with the frame, the GI having a length in a time domain larger or longer than a channel span; and extracting OFDM information comprising a first OFDM information starting from a first point after the channel span to a first end point within the frame.

In an orthogonal frequency division multiplex (OFDM) communication system, a receiver is provided. The receiver comprises: a received frame; a guard interval (GI) associated with the frame, the GI having a length in a frequency domain larger or longer than a channel span; and a first diversity constructor extracting OFDM information comprising a first OFDM information starting from a first point after the channel span to a first end point within the frame.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is prior art OFDM duo-antenna diversity receiver.

FIG. 2 is an example of an OFDM symbol in accordance with some embodiments of the invention.

FIG. 3 is an example of an OFDM receiver in accordance with some embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to taking into consideration of a channel span and exploring the structure of an OFDM symbol. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of taking into consideration of a channel span and exploring the structure of an OFDM symbol described herein. The non-processor circuits may include, but are not limited to, a radio receiver, a radio transmitter, signal drivers, clock circuits, power source circuits, and user input devices. As such, these functions may be interpreted as steps of a method to perform taking into consideration of a channel span and exploring the structure of an OFDM symbol. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

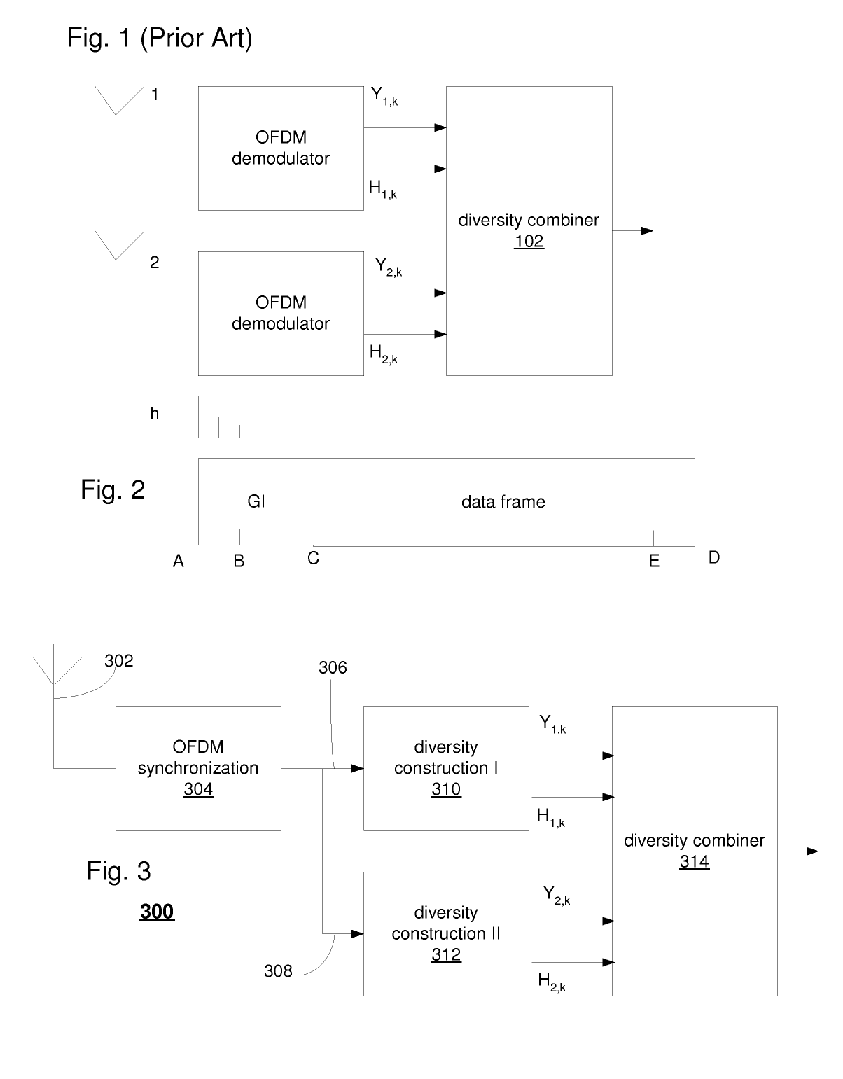

Referring to FIG. 1, a typical, conventional OFDM duo-antenna diversity receiver is shown. As can be seen, the receiver 100 has more than one antenna. For each antenna, a separate OFDM demodulator is associated. Each antenna has its own separate and distinct channel characteristics. Signals from both antennas (1 and 2) are demodulated separately. Values of the data sub-carrier in an OFDM symbol together with channel state information are provided to the diversity combiner block 102. The values includes received symbol fast Fourier transform (FFT) Y_{1,k} and channel characteristic H_{1,k} for channel 1, and received symbol fast Fourier transform (FFT) Y_{2,k} and channel characteristic H_{2,k} for channel 2.

Referring to FIG. 2 a frame structure of an OFDM with guard interval (GI) is shown. If GI is relatively larger than channel span or longer than channel span, extraction of OFDM information can be made starting at any points between B and C. Therefore, choosing any point just after B and choosing just before C would yield different snapshots of a received signal. As can be appreciated, diversity is thus achieved. GI is defined between point A and point C in the time domain. Channel span is defined as the longest echo compared to the first arrival, shown as delta (Δ) between A and B in the time domain. By way of example, due to the changes or the vagaries of the channel, it is preferable to choose at least two different snapshots of a received signal as further apart as possible between point B and point D. Point D is defined as the end point of the data symbol. In other words, the first snapshot spans point B to point E, and the second snap shot spans point C to point D.

FIG. 3 is a diversity receiver 300 at a receiver end in an OFDM system. Antenna 302 receives signals wirelessly and feeds the received signals to an OFDM synchronizer 304 for OFDM synchronization. Upon synchronization, the synchronized information branches into two separate paths. i.e. a first path 306 and a second path 308. The first path 306 is subjected to a first diversity constructor 310 for the extraction of information contained, for example, in a first snapshot. Similarly, the second path 308 is subjected to a second diversity constructor 312 for the extraction of information contained, for example, in a second snapshot. The first snapshot may be time information between point B to point E. The second snapshot may be time information between point C to point D. it is desirous to keep the two snapshots as further apart as possible within point B to point D. The extracted information including received symbol fast Fourier transform (FFT) Y_{1,k} and channel characteristic H_{1,k} for channel 1, and received symbol fast Fourier transform (FFT) Y_{2,k} and channel characteristic H_{2,k} for channel 2 is input into a diversity combiner 314 for minimizing, or reducing channel related inaccuracies.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Terms and phrases used in this document, and variations thereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “normal,” “standard,” and terms of similar meaning should not be construed as limiting the item described to a given time period or to an item available as of a given time, but instead should be read to encompass conventional, traditional, normal, or standard technologies that may be available now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

What is claimed is:

1. In an orthogonal frequency division multiplex (OFDM) communication system, a method at a receiver end comprising the steps of:
providing a frame;
providing a guard interval (GI) associated with the frame, the GI having a length in a time domain larger or longer than a channel span; and
extracting OFDM information comprising a first OFDM information starting from a first point after the channel span to a first end point within the frame.

2. The method of claim 1 further comprising the step of extracting of a second OFDM information starting from a second point after the channel span to a second end point within the frame.

3. The method of claim 1, wherein the OFDM information comprise received signal information and channel information.

4. The method of claim 1, wherein the extracting step comprises extracting at least two sets of OFDM information.

5. The method of claim 1, wherein the extracting step comprises extracting two sets of OFDM information as further apart as possible within a point immediately after the channel span to a point at an opposite end of the frame.

6. In an orthogonal frequency division multiplex (OFDM) communication system, a receiver comprising:
a received frame;
a guard interval (GI) associated with the frame, the GI having a length in a time domain larger or longer than a channel span; and
a first diversity constructor extracting OFDM information comprising a first OFDM information starting from a first point after the channel span to a first end point within the frame.

7. The receiver of claim 6 further comprising a second diversity constructor extracting a second OFDM information starting from a second point after the channel span to a second end point within the frame.

8. The receiver of claim 6, wherein the OFDM information comprises received signal information and channel information.

9. The receiver of claim 6, wherein a set of diversity constructors extract at least two sets of OFDM information.

10. The receiver of claim 6, wherein two diversity constructors extract two sets of OFDM information as further apart as possible within a point immediately after the channel span to a point at an opposite end of the frame.
